(19) United States
(12) Patent Application Publication
(10) Pub. No.: US 2014/0365918 A1
(43) Pub. Date: Dec. 11, 2014

(54) INCORPORATING EXTERNAL DYNAMIC CONTENT INTO A WHITEBOARD

(71) Applicant: Microsoft Corporation, Redmond, WA (US)

(72) Inventors: Gary Caldwell, Redmond, WA (US); Nathan Fish, Seattle, WA (US); Isaac Jacobsen, Bothell, WA (US)

(21) Appl. No.: 13/914,260

(22) Filed: Jun. 10, 2013

(51) Int. Cl. G06F 3/0481

(52) U.S. Cl. CPC G06F 3/0481
USPC 715/753

(57) ABSTRACT

Dynamic content may be included on a digital whiteboard canvas. The dynamic content includes external content that changes. For example, web pages, images from an external source, presentations, shared displays, newsfeeds, and the like may be placed on the whiteboard. The user may interact with the dynamic content in either a live mode or an annotation mode. An annotation mode allows a user to annotate the dynamic content. For example, a user may ink on top of dynamic content. If a size of a dynamic content object changes, a size of the inking may also change. Different viewing modes are used to interact with the dynamic content on the whiteboard. A live mode allows a user to interact with the dynamic content and an annotation mode allows a user to annotate the dynamic content. A “snapshot” of the dynamic content may be created and stored with the whiteboard.

### BACKGROUND

Different computer applications such as notebook applications and whiteboard applications allow a user to view and save a variety of different static content. These applications are typically used for free-form information gathering. For example, an application may allow a user to include notes, links, images of web pages, pictures, documents, and the like on a canvas. Different users may be able to share the canvas. For example, different users may be allowed to read the canvas, edit content on the canvas, and the like.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Dynamic content may be included on a digital whiteboard. The dynamic content includes external content that dynamically changes. For example, web pages, images from an external source, presentations, shared displays, newsfeeds, and the like may be placed on the whiteboard. The display of the dynamic content on the whiteboard may be updated in real time or frozen. The user may interact with the dynamic content in either a live mode or an annotation mode. An annotation mode allows a user to annotate the dynamic content. For example, a user may ink on top of a web page or an image that is dynamically updated. If the size of a dynamic content object changes, the size of the inking may also change. Different viewing modes are used to interact with the dynamic content on the whiteboard. A live mode allows a user to interact with the dynamic content and an annotation mode allows a user to annotate the dynamic content. A “snapshot” of the dynamic content may be created and stored with the whiteboard. For example, a user may save a snapshot of dynamic content before it changes. If a whiteboard is being used for a live presentation, a snapshot may be taken to store a state of the live presentation.

### BRIEF DESCRIPTION OF THE DRAWINGS

FIG. 1 shows a system that includes dynamic content on a whiteboard;

FIG. 2 illustrates exemplary whiteboards showing dynamic content and annotating dynamic content;

FIG. 3 illustrates exemplary whiteboards showing dynamic content and annotating dynamic content;

FIG. 4 shows taking a snapshot of dynamic content;

FIG. 5 shows resizing an image including annotations;

FIG. 6 shows a shared display on a whiteboard and taking snapshots of a live shared display;

FIG. 7 illustrates including dynamic content on a whiteboard;

FIG. 8 shows a diagram illustrating performing an operation in response to an interaction with a dynamic content set to a live mode;

FIG. 9 shows a diagram illustrating performing an operation in response to an interaction with a dynamic content set to an annotate mode;

FIG. 10 illustrates an exemplary online system for interacting with dynamic content on a whiteboard;

FIG. 11 is a block diagram illustrating example physical components of a computing device;

FIG. 12A illustrates a mobile computing environment;

FIG. 12B is a block diagram illustrating components of a mobile computing device; and

FIG. 13 illustrates an exemplary system architecture.

### DETAILED DESCRIPTION

Referring now to the drawings, in which like numerals represent like elements, various embodiment will be described.

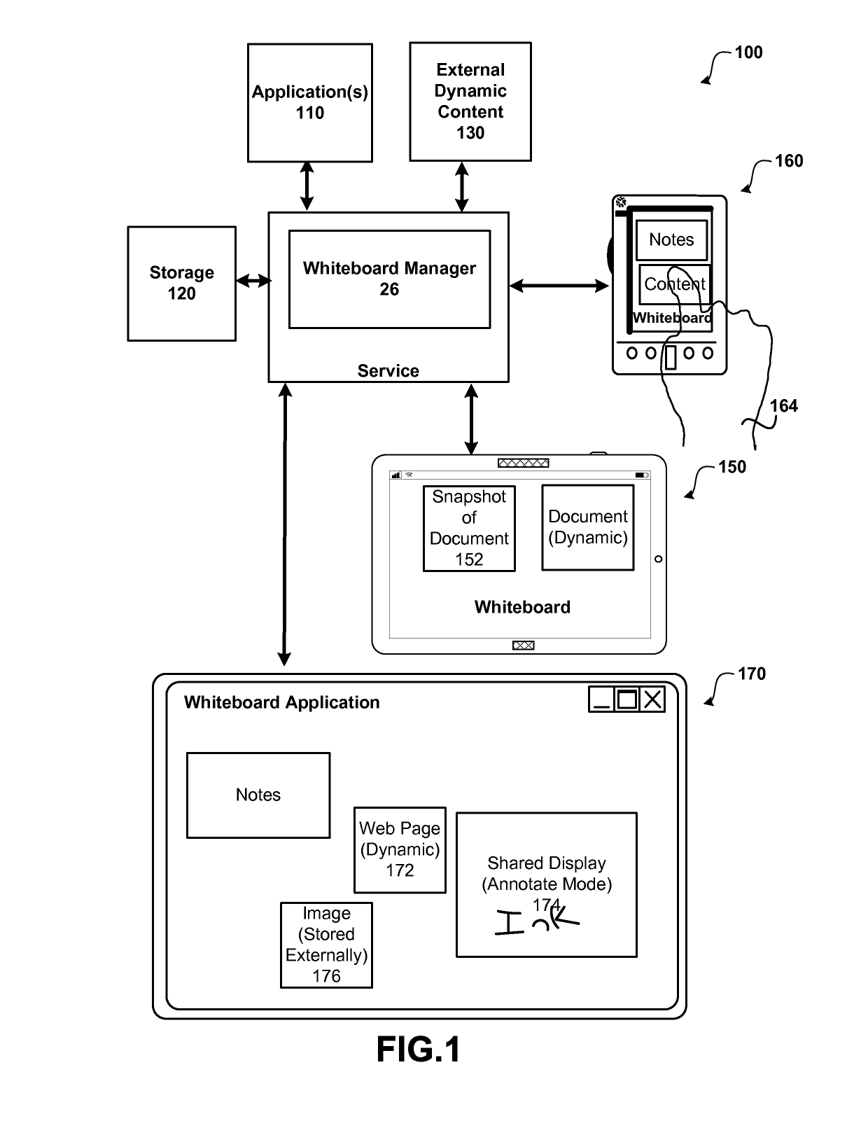

FIG. 1 shows a system that includes dynamic content on a whiteboard.

As illustrated, system 100 includes application(s) 110, contextual storage 120, external dynamic content 130, whiteboard manager 26, tablet computing device 150, smart phone device 160, and computing device 170.

Whiteboard manager 26 is configured to perform operations relating to interacting with and including dynamic content on a digital whiteboard. The dynamic content includes external content that dynamically changes. For example, web pages (e.g. web page 172), images from an external source (e.g. image 176), presentations, shared displays (e.g. shared display 174), newsfeeds, and the like may be placed on the whiteboard by whiteboard manager 26. Whiteboard manager 26 dynamically updates the display of the dynamic content as it changes. Whiteboard manager 26 may also set the state of the dynamic content such that it is not updated.

For example, user 164 may interact with the dynamic content in either a live mode or an annotation mode. An annotation mode allows a user to annotate the dynamic content. For example, a user may ink on top of, a shared display as shown on shared display 174, a web page, a presentation, an image, and the like that is dynamically updated. If a size of a dynamic content object changes, a size of the inking may also change. A “snapshot” 152 of the dynamic content may be created and stored on the whiteboard. For example, a user may save a snapshot of dynamic content before it changes. If a whiteboard is being used for a live presentation, a snapshot may be taken to store a current state of the live presentation

In order to facilitate communication with whiteboard manager 26, one or more callback routines, may be implemented. Application (s) 110 may be a variety of applications, such as whiteboard applications, business productivity applications, entertainment applications, music applications, travel applications, video applications, and the like. Generally, application(s) 110 may be any application that is used in a whiteboard environment. The application(s) 110 may be configured to receive different types of input (e.g. speech input, touch input, keyboard input (e.g. a physical keyboard and/or Software Input Panel (SIP)) and/or other types of input.

System 100 as illustrated comprises one or more touch screen input devices, such as tablet computing device 150 and smart phone device 160, that detects when a touch input has been received (e.g. a finger touching or nearly touching the touch screen). Any type of touch screen may be utilized that detects a user's touch input. More details are provided below.

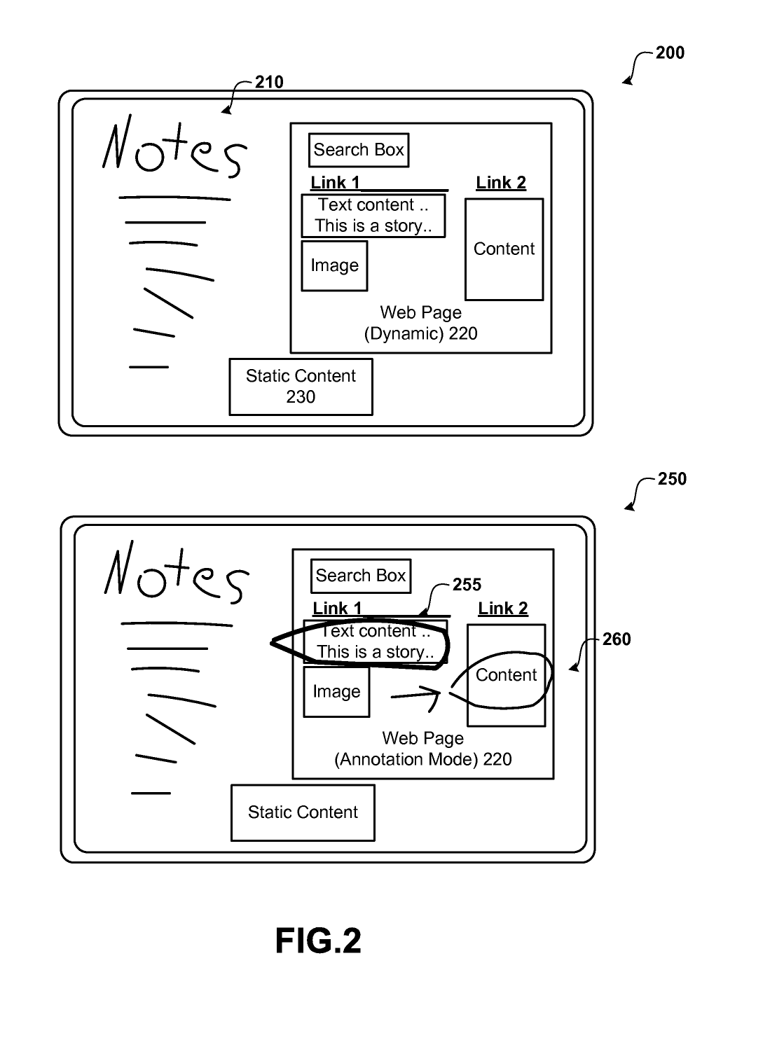

FIG. 2 illustrates exemplary whiteboards showing dynamic content and annotating dynamic content.

Display 200 shows a whiteboard including dynamic content and static content. A whiteboard, such as whiteboard 200, may store many different types of static content and dynamic content. For example, a whiteboard may include, but is not limited to: typed and handwritten notes, documents, links, web pages, shared displays, tables and charts, sketches, videos and other media, and the like. Content included in the whiteboard may be static content that is not updated or dynamic content that is dynamically updated. As illustrated, whiteboard 200 shows handwritten inked notes 210, a dynamic web page 220 including links, images, content and a search box and static content 230.

Display 250 illustrates web page 220 set to an annotation mode. According to an embodiment, while dynamic content is placed into an annotation mode, a user may annotate the dynamic content. In the current example, a user has inked a circle 255 around the content under Link 1 and has drawn an arrow and circled 260 content under Link 2. A user may save a snapshot of the annotations and the web page and place the snapshot somewhere within the whiteboard. A user may change the web page back to live mode at any time. According to an embodiment, when the web page dynamically changes and removes content having annotations associated with them, a snapshot of the web page is automatically taken.

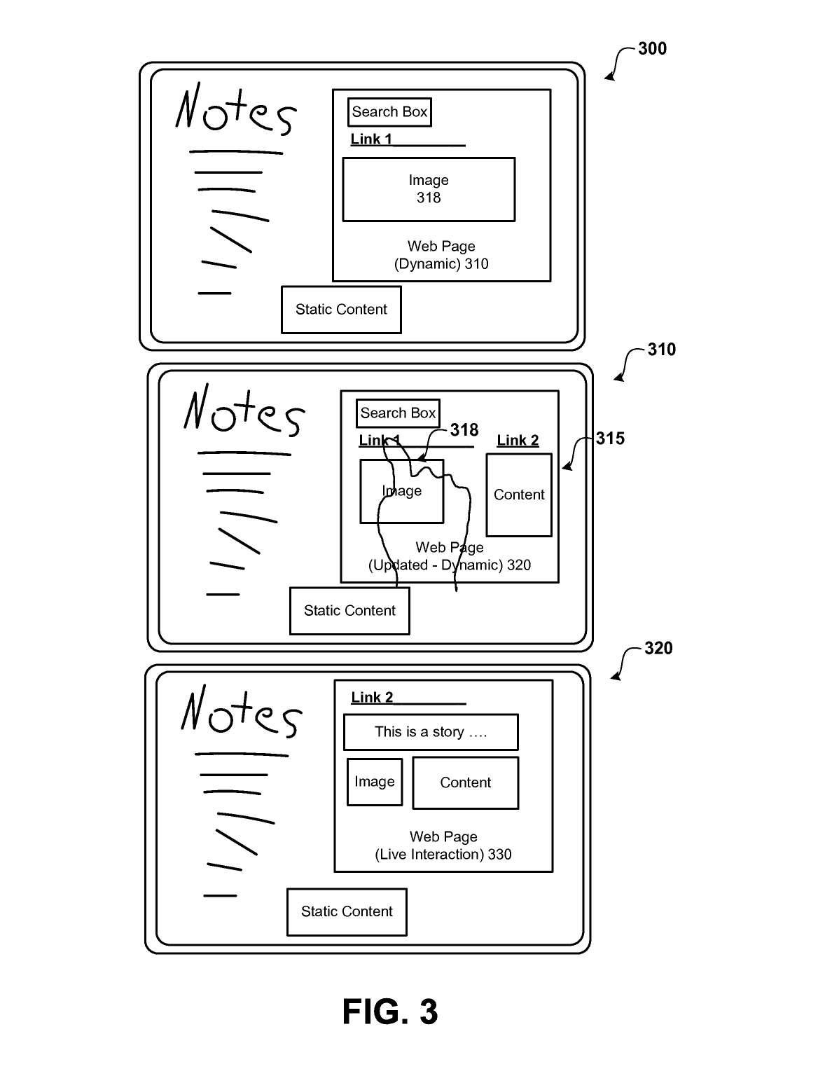

FIG. 3 illustrates exemplary whiteboards showing dynamic content and annotating dynamic content.

Display 300 shows a whiteboard including dynamic content and static content. As illustrated, whiteboard 300 shows handwritten inked notes, static content, a dynamic web page 310 including a search box, a link (Link 1), and an image. While web page 310 is set to a live mode, web page 310 on whiteboard 300 is updated in real time as changes are made by the external website to web page 310.

Display 310 shows a whiteboard including dynamic content that is automatically updated in response to a change made to the externally stored content. As illustrated, whiteboard 310 shows handwritten inked notes, static content, a dynamic web page 320 including a search box, two links (Link 1 and Link 2), an image and content. Web page 320 is dynamically updated in response to the externally stored web page being updated. In the current example, the update to the web page includes resizing the image 318 and adding Link 2 and the content beneath link 2 (315).

Display 320 shows user interaction with dynamic content displayed the whiteboard. For example, assume that a user 318 selects Link 1 on web page 320. In response to selecting link 1, the display of the web page changes to show the content associated with Link 1. A user may continue to navigate the web page on the whiteboard in a same manner as they would navigate the associated external website.

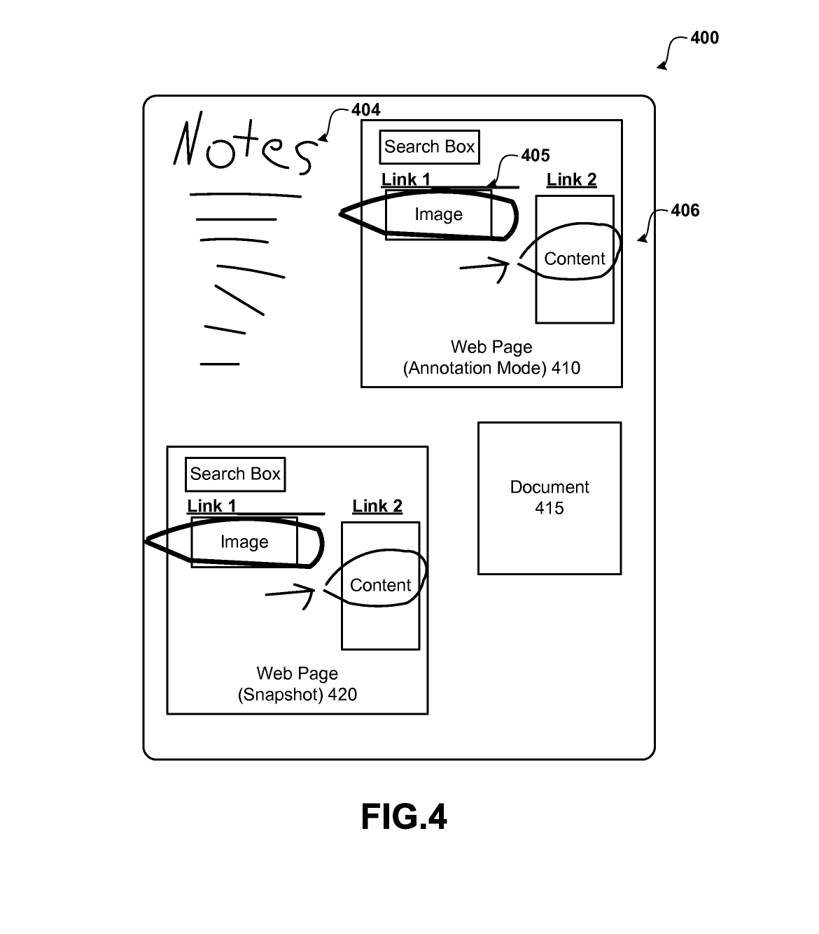

FIG. 4 shows taking a snapshot of dynamic content.

As illustrated, whiteboard 400 shows handwritten inked notes 404, a dynamic web page 410 set to an annotation mode, a document 415, and a snapshot 420 of web page 410.

In the current example, a user has inked a circle 405 around the image under Link 1 and has drawn an circle 406 around content under Link 2. A user may save a snapshot of the annotations and the web page and place the snapshot somewhere within the whiteboard. In the current example, the user has taken a snapshot of web page 410 and placed the snapshot 420 on another area of the whiteboard.

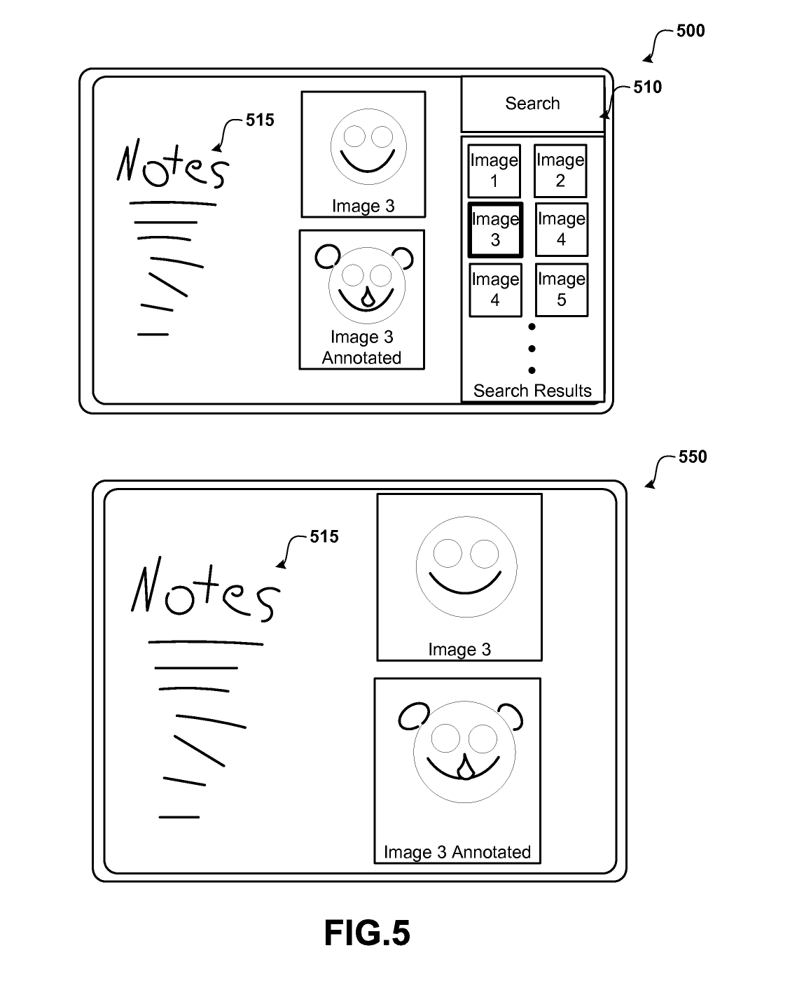

FIG. 5 shows resizing an image including annotations.

As illustrated, whiteboard 500 shows handwritten inked notes 515, image 3 and image 3 annotated. According to an embodiment, a user may search for content to include in a whiteboard using a search box 510. In the current example, a user has searched for images and has selected image 3 to include on the whiteboard. After inserting the image into the whiteboard, the user has annotated image 3 to include ears and a nose. While whiteboard 500 shows a separate copy of image 3 being annotated, the image obtained from the search may be annotated.

Whiteboard 550 shows resizing the portion of the whiteboard that includes the handwritten inked notes, Image 3 and Image 3 annotated. Ink annotations are associated with the image to which they below. When content is resized that includes annotations, not only does the image scale but the ink also scales. While the current example, illustrated resizing the whiteboard, an individual object on the whiteboard may be resized without resizing other objects. For example, the annotated Image 3 may be resized without resizing the handwritten inked notes.

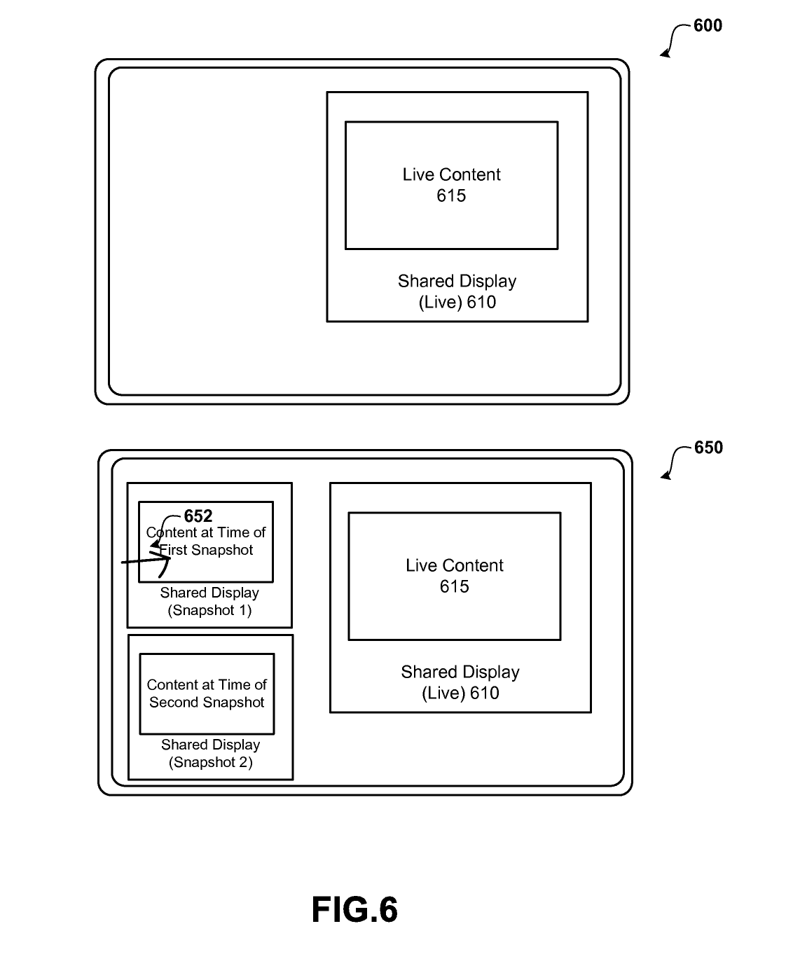

FIG. 6 shows a shared display on a whiteboard and taking snapshots of a live shared display.

As illustrated, whiteboard 600 shows a shared display 610 including live content 615. For example, shared display 610 may be a remote desktop session or some other shared screen, such as a presentation.

Whiteboard 650 shows a shared display 610 including live content 615 and snapshot 1 and snapshot 2 of the shared displays. A user may take snapshots of live content on the whiteboard as it occurs. In the current example, a user has taken a first snapshot (Snapshot 1) that captures the shared display at one time and has taken a second snapshot (Snapshot 2) that captures the shared display at another time. The user has also annotated 652 Snapshot 1.

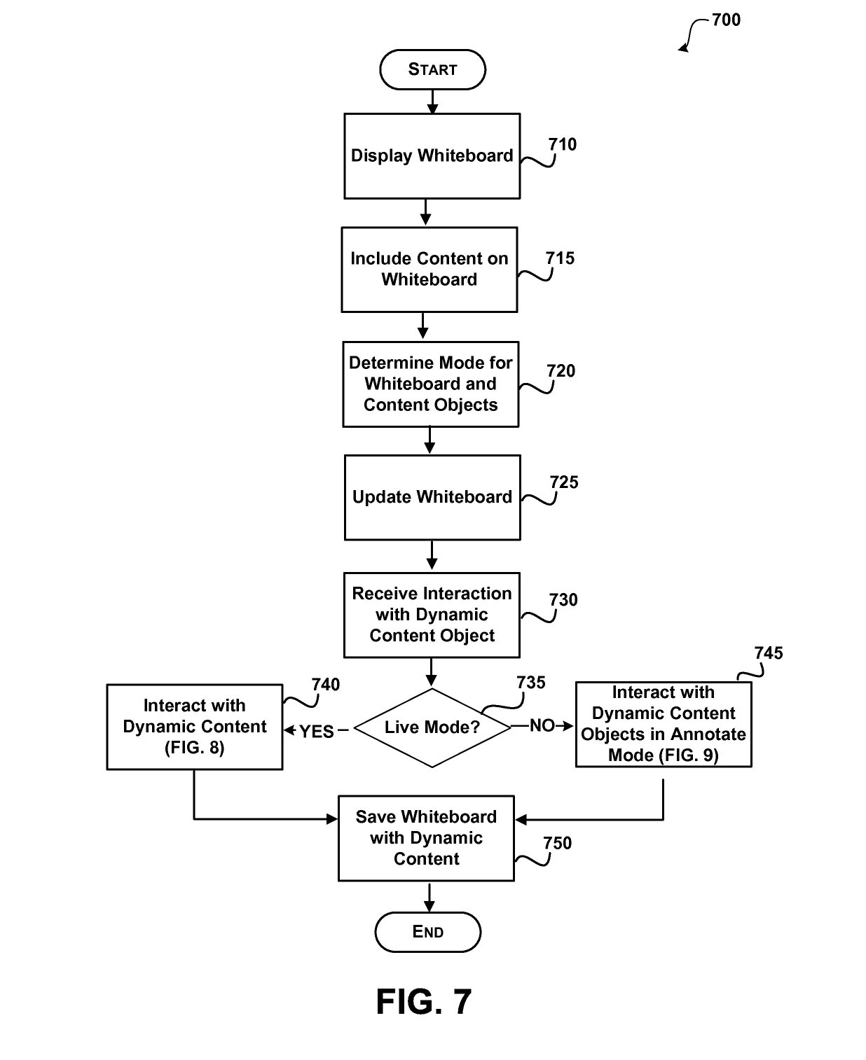

FIGS. 7, 8 and 9 illustrate interacting with and including dynamic content on a whiteboard. When reading the discussion of the routines presented herein, it should be appreciated that the logical operations of various embodiments are implemented (1) as a sequence of computer implemented acts or program modules running on a computing system and/or (2) as interconnected machine logic circuits or circuit modules within the computing system. The implementation is a matter of choice dependent on the performance requirements of the computing system implementing the invention. Accordingly, the logical operations illustrated and making up the embodiments described herein are referred to variously as operations, structural devices, acts or modules. These operations, structural devices, acts and modules may be implemented in software, in firmware, in special purpose digital logic, and any combination thereof. While the operations are shown in a particular order, the order of the operations may change, be performed in parallel, depending on the implementation.

FIG. 7 illustrates including dynamic content on a whiteboard.

After a start operation, the process moves to operation 710, where a whiteboard is displayed. The whiteboard may be displayed on different types of computing devices, such as desktop computing devices, laptop computing devices, tablets, smart phones, and the like. The whiteboard can store many different types of static content and dynamic content. For example, a whiteboard may include, but is not limited to: typed and handwritten notes, documents, links, web pages, shared displays, tables and charts, sketches, videos and other media, and the like.

Flowing to operation 715, content is included on the whiteboard. The content may be included anywhere on the whiteboard where there is room. The size of the whiteboard grows as content is placed on the whiteboard. The whiteboard may include both static content that is not updated and dynamic content that is dynamically updated as the source content changes.

Transitioning to operation 720, a mode is determined for the whiteboard and the content objects on the whiteboard. According to an embodiment, the whiteboard includes two modes of operation including a live mode and an annotation mode. The live mode automatically updates dynamic content and allows the user to interact with the dynamic content. For example, a user may select a link on a dynamic web page that is included on the whiteboard. The annotate mode allows the user to annotate the dynamic content. For example, a user may draw ink on the dynamic content. While the annotate mode is active, the automatic updates for the dynamic content in the annotate mode is not performed.

The selected mode of operation may be configured to apply to all/portion of the dynamic content. According to an embodiment, the mode applies to the entire whiteboard. According to another embodiment, the mode may be set for each dynamic content object. For example, one dynamic content object may be set to annotate mode while other dynamic content objects are set to live mode.

Moving to operation 725, the whiteboard is automatically updated. Dynamic content objects that are set to the live mode are updated when the source content changes. Dynamic content objects that are set to the annotate mode are not updated when the source content changes.

Flowing to operation 730, an interaction is received with a dynamic content object.

Transitioning to decision operation 735, a determination is made as to whether the current mode for the dynamic content is the live mode. When the dynamic content object is set to the live mode, the process flows to operation 740. When the dynamic content object is set to the annotate mode, the process flows to operation 745.

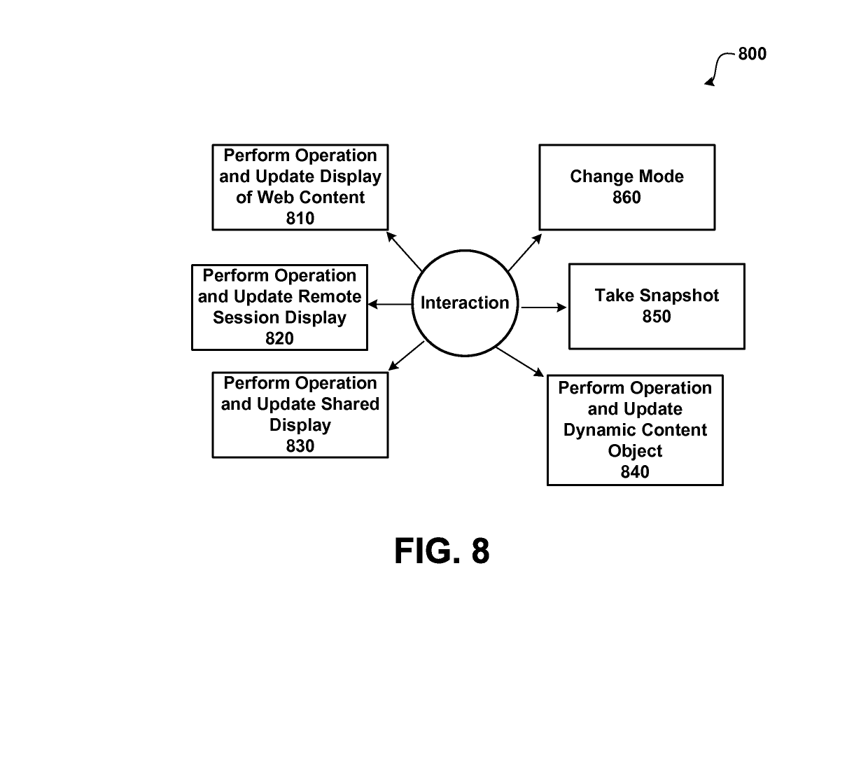

At operation 740, the dynamic content object may be interacted with in live mode. For example, a user may select a link on a dynamic web page to change the display of the web page. See FIG. 8 and related discussion.

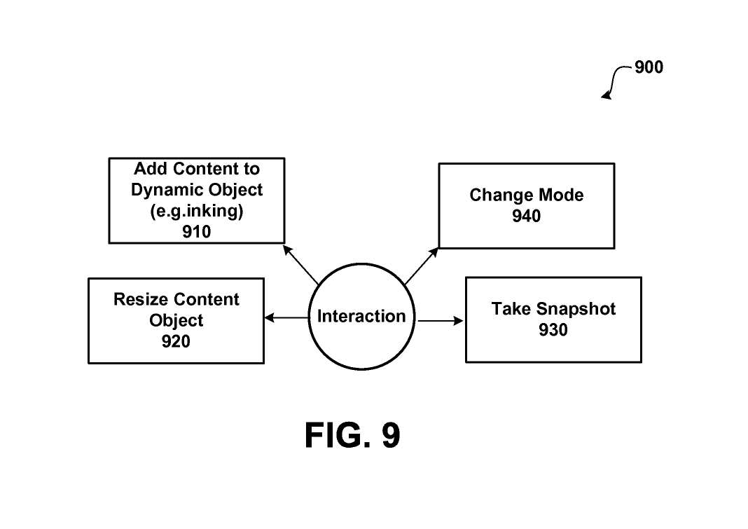

At operation 745, the dynamic content object may be interacted with in annotate mode. For example, a user may draw on the dynamic content object. See FIG. 9 and related discussion.

Moving to operation 750, the whiteboard is saved when determined. The whiteboard may be saved manually/automatically and may be saved to a local storage and/or a network storage location. According to an embodiment, when the dynamic content is accessible through a link, such as a Uniform Resource Locator (URL), the link is included in the file. According to another embodiment, both the link to the dynamic content is stored along with a snapshot of the content automatically made before the whiteboard is closed. In this way, the user may decide to use the snapshot at a later time.

The process then flows to an end operation and returns to processing other actions.

FIG. 8 shows a diagram illustrating performing an operation in response to an interaction with a dynamic content set to a live mode.

A user may interact with dynamic content in live mode as if they were interacting with the content at its source (e.g. at the website). The dynamic content may include a variety of different content, such as but not limited to: web pages, spreadsheets, tables, charts, newsfeeds, documents, presentations, remote desktop sessions, shared displays, and the like.

Operation 810 shows updating a web page dynamic content object that received an interaction. According to an embodiment, a user may navigate the web page just as if they were interacting with the web page in a standalone web browser. For example, the user may select a link, scroll the web page, enter content, perform a search and the like.

Operation 820 shows interacting with a remote display using a remote session display dynamic object on the whiteboard. For example, a user may start an application on the remote display and see the application running on the whiteboard.

Operation 830 shows interacting with a shared display using a shared display dynamic content object. For example, a user may be sharing a display with one or more other users for collaboration on a document or some other task.

Operation 840 shows interacting with some other type of dynamic content object. Generally, any type of dynamic content may be included on the whiteboard. For example, the dynamic content object may be a television application (e.g. viewing television programs), a movie application, and the like.

Operation 850 shows taking a snapshot of content displayed on the whiteboard. For example, a user may take a snapshot of live content and place the snapshot on the whiteboard for later use. A user may take a snapshot of all/portion of a dynamic content object. A user may also take a snapshot of other content.

Taking a snapshot creates an image of the currently displayed content on the whiteboard selected for the snapshot.

Operation 860 shows changing the mode from the live mode to the annotate mode. For example, a user may select a menu option, perform a gesture, or perform some other operation to change the mode.

FIG. 9 shows a diagram illustrating performing an operation in response to an interaction with a dynamic content set to an annotate mode.

A user may interact with dynamic content in the annotated mode as if they were interacting with a static image of the dynamic content.

Operation 910 shows adding content to the dynamic content object. For example, a user may perform inking on the content object, type on the content object, draw on the content object, put a title on the object, and the like.

Operation 920 shows, resizing a content object while in annotate mode. Generally, a user may resize a content object as if they were interacting with an image. According to an embodiment, any content added to the drawing object (e.g. inking) is scaled in relation to the content object.

Operation 930 shows taking a snapshot of content displayed on the whiteboard. For example, a user may take a snapshot of content and place the snapshot on the whiteboard for later use. A user may take a snapshot of all/portion of a dynamic content object. A user may also take a snapshot of other content. Taking a snapshot creates an image of the currently displayed content on the whiteboard selected for the snapshot.

Operation 940 shows changing the mode from the annotate mode to the live mode. For example, a user may select a menu option, perform a gesture, or perform some other operation to change the mode. According to an embodiment, when the mode is changed to live mode, a display of any content added to the dynamic content while in annotate mode is removed from the display. The content added is redisplayed when the mode is changed back to the annotate mode. According to an embodiment, the added annotation content is anchored back at the logical spot where it was created even if the display changes.

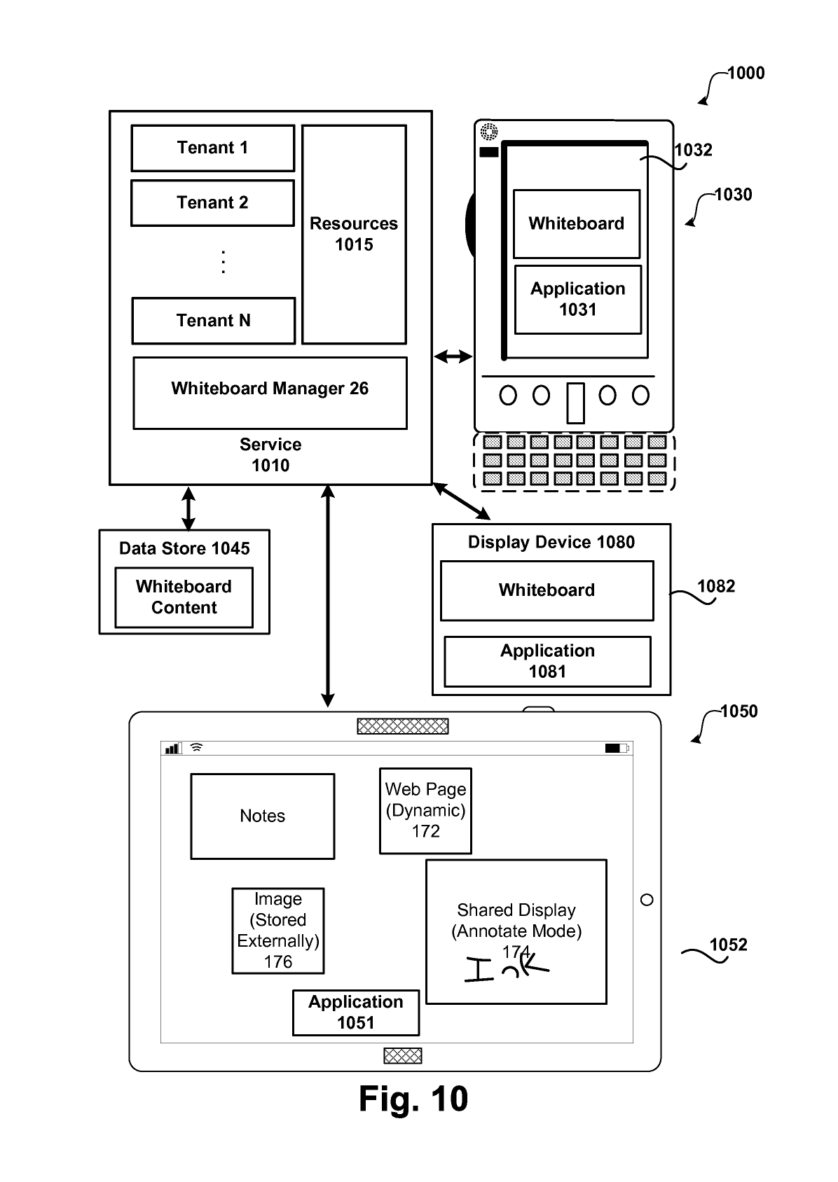

FIG. 10 illustrates an exemplary online system for interacting with dynamic content on a whiteboard. As illustrated, system 1000 includes service 1010, data store 1045, touch screen input device 1050 (e.g. a table/slate), smart phone 1030 and display device 1080.

As illustrated, service 1010 is a cloud based and/or enterprise based service that may be configured to provide services, such as services related to various applications (e.g. whiteboards, searching, games, browsing, locating, productivity services (e.g. spreadsheets, documents, presentations, charts, messages, and the like)). The service may be interacted with using different types of input/output. For example, a user may use speech input, touch input, hardware based input, and the like. The service may provide speech output that combines pre-recorded speech and synthesized speech. Functionality of one or more of the services/applications provided by service 1010 may also be configured as a client/server based application.

As illustrated, service 1010 is a multi-tenant service that provides resources 1015 and services to any number of tenants (e.g. Tenants 1-N). Multi-tenant service 1010 is a cloud based service that provides resources/services 1015 to tenants subscribed to the service and maintains each tenant's data separately and protected from other tenant data.

System 1000 as illustrated comprises a touch screen input device 1050 (e.g. a slate/tablet device) and smart phone 1030 that detects when a touch input has been received (e.g. a finger touching or nearly touching the touch screen). Any type of touch screen may be utilized that detects a user's touch input. For example, the touch screen may include one or more layers of capacitive material that detects the touch input. Other sensors may be used in addition to or in place of the capacitive material. For example, Infrared (IR) sensors may be used. According to an embodiment, the touch screen is configured to detect objects that in contact with or above a touchable surface. Although the term “above” is used in this description, it should be understood that the orientation of the touch panel system is irrelevant. The term “above” is intended to be applicable to all such orientations. The touch screen may be configured to determine locations of where touch input is received (e.g. a starting point, intermediate points and an ending point). Actual contact between the touchable surface and the object may be detected by any suitable means, including, for example, by a vibration sensor or microphone coupled to the touch panel. A non-exhaustive list of examples for sensors to detect contact includes pressure-based mechanisms, micro-machined accelerometers, piezoelectric devices, capacitive sensors, resistive sensors, inductive sensors, laser vibrometers, and LED vibrometers.

According to an embodiment, smart phone 1030, touch screen input device 1050, and device 1080 are configured with multimodal input/output and each include an application (1031, 1051, 1081).

As illustrated, touch screen input device 1050, smart phone 1030, and display device 1080 shows exemplary displays 1052/1032/1082 showing the use of an application, such as a whiteboard application that includes dynamic external content. Data may be stored on a device (e.g. smart phone 1030, device 1050 and/or at some other location (e.g. network data store 1045). Data store 1045, or some other store, may be used to store contextual information as well as other data. The applications used by the devices may be client based applications, server based applications, cloud based applications and/or some combination. According to an embodiment, display device 1080 is a device such as a MICROSOFT XBOX coupled to a display.

Whiteboard manager 26 is configured to perform operations relating to interacting with dynamic content on a whiteboard as described herein. While manager 26 is shown within service 1010, the functionality of the manager may be included in other locations (e.g. on smart phone 1030 and/or device 1050 and/or device 1080).

The embodiments and functionalities described herein may operate via a multitude of computing systems including, without limitation, desktop computer systems, wired and wireless computing systems, mobile computing systems (e.g., mobile telephones, netbooks, tablet or slate type computers, notebook computers, and laptop computers), hand-held devices, multiprocessor systems, microprocessor-based or programmable consumer electronics, minicomputers, and mainframe computers.

In addition, the embodiments and functionalities described herein may operate over distributed systems (e.g., cloud-based computing systems), where application functionality, memory, data storage and retrieval and various processing functions may be operated remotely from each other over a distributed computing network, such as the Internet or an intranet. User interfaces and information of various types may be displayed via on-board computing device displays or via remote display units associated with one or more computing devices. For example user interfaces and information of various types may be displayed and interacted with on a wall surface onto which user interfaces and information of various types are projected. Interaction with the multitude of computing systems with which embodiments of the invention may be practiced include, keystroke entry, touch screen entry, voice or other audio entry, gesture entry where an associated computing device is equipped with detection (e.g., camera) functionality for capturing and interpreting user gestures for controlling the functionality of the computing device, and the like.

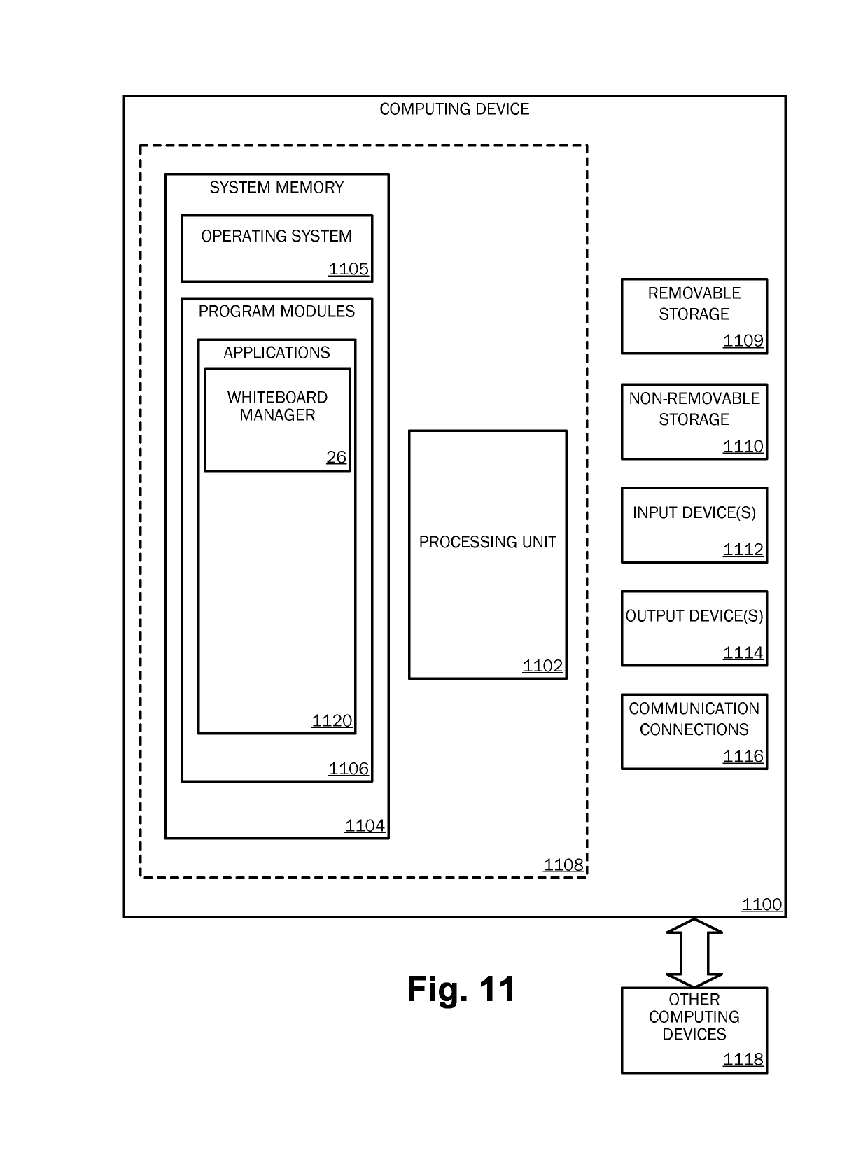

FIGS. 11-13 and the associated descriptions provide a discussion of a variety of operating environments in which embodiments of the invention may be practiced. However, the devices and systems illustrated and discussed with respect to FIGS. 11-13 are for purposes of example and illustration and are not limiting of a vast number of computing device configurations that may be utilized for practicing embodiments of the invention, described herein.

FIG. 11 is a block diagram illustrating physical components (i.e., hardware) of a computing device 1100 with which embodiments of the invention may be practiced. The computing device components described below may be suitable for the computing devices described above. In a basic configuration, the computing device 1100 may include at least one processing unit 1102 and a system memory 1104. Depending on the configuration and type of computing device, the system memory 1104 may comprise, but is not limited to, volatile storage (e.g., random access memory), non-volatile storage (e.g., read-only memory), flash memory, or any combination of such memories. The system memory 1104 may include an operating system 1105 and one or more program modules 1106 suitable for running software applications 1120 such as the whiteboard manager 26. The operating system 1105, for example, may be suitable for controlling the operation of the computing device 1100. Furthermore, embodiments of the invention may be practiced in conjunction with a graphics library, other operating systems, or any other application program and is not limited to any particular application or system. This basic configuration is illustrated in FIG. 11 by those components within a dashed line 1108. The computing device 1100 may have additional features or functionality. For example, the computing device 1100 may also include additional data storage devices (removable and/or non-removable) such as, for example, magnetic disks, optical disks, or tape. Such additional storage is illustrated in FIG. 11 by a removable storage device 1109 and a non-removable storage device 1110.

As stated above, a number of program modules and data files may be stored in the system memory 1104. While executing on the processing unit 1102, the program modules 1106 (e.g., the whiteboard manager 26) may perform processes including, but not limited to, one or more of the stages of the methods and processes illustrated in the figures. Other program modules that may be used in accordance with embodiments of the present invention may include electronic mail and contacts applications, word processing applications, spreadsheet applications, database applications, slide presentation applications, drawing or computer-aided application programs, etc.

Furthermore, embodiments of the invention may be practiced in an electrical circuit comprising discrete electronic elements, packaged or integrated electronic chips containing logic gates, a circuit utilizing a microprocessor, or on a single chip containing electronic elements or microprocessors. For example, embodiments of the invention may be practiced via a system-on-a-chip (SOC) where each or many of the components illustrated in FIG. 11 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality, described herein, with respect to the whiteboard manager 26 may be operated via application-specific logic integrated with other components of the computing device 1100 on the single integrated circuit (chip). Embodiments of the invention may also be practiced using other technologies capable of performing logical operations such as, for example, AND, OR, and NOT, including but not limited to mechanical, optical, fluidic, and quantum technologies. In addition, embodiments of the invention may be practiced within a general purpose computer or in any other circuits or systems.

The computing device 1100 may also have one or more input device(s) 1112 such as a keyboard, a mouse, a pen, a sound input device, a touch input device, etc. The output device(s) 1114 such as a display, speakers, a printer, etc. may also be included. The aforementioned devices are examples and others may be used. The computing device 1100 may include one or more communication connections 1116 allowing communications with other computing devices 1118. Examples of suitable communication connections 1116 include, but are not limited to, RF transmitter, receiver, and/or transceiver circuitry; universal serial bus (USB), parallel, and/or serial ports.

The term computer readable media as used herein may include computer storage media. Computer storage media may include volatile and nonvolatile, removable and non-removable media implemented in any method or technology for storage of information, such as computer readable instructions, data structures, or program modules. The system memory 1104, the removable storage device 1109, and the non-removable storage device 1110 are all computer storage media examples (i.e., memory storage.) Computer storage media may include RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 1100. Any such computer storage media may be part of the computing device 1100. Computer storage media does not include a carrier wave or other propagated or modulated data signal.

Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

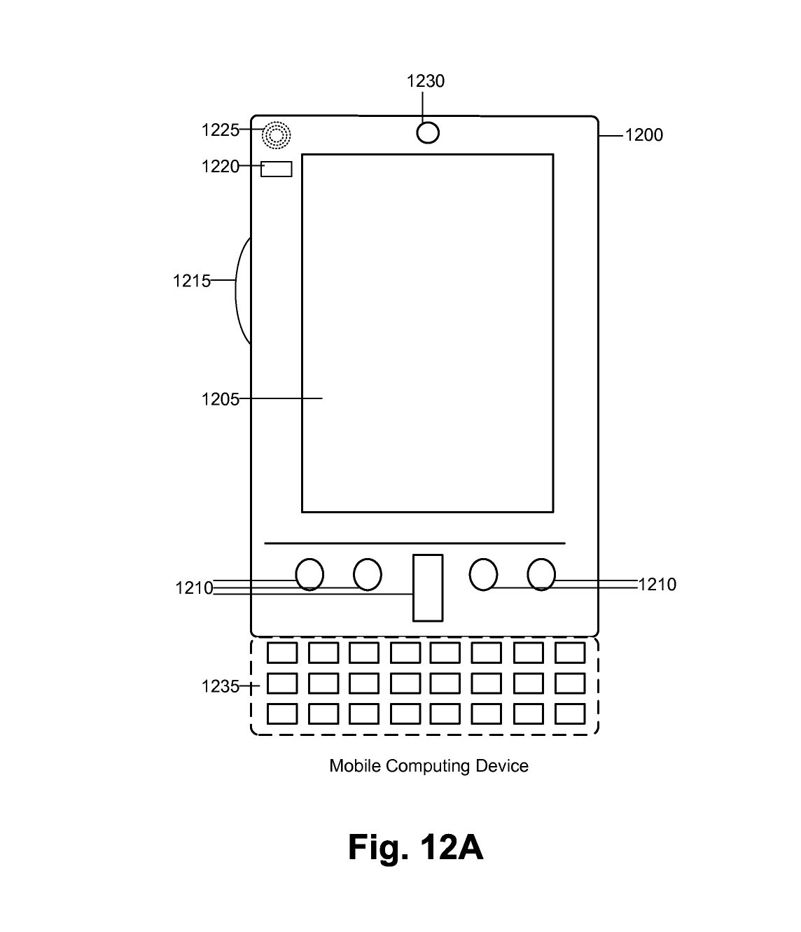

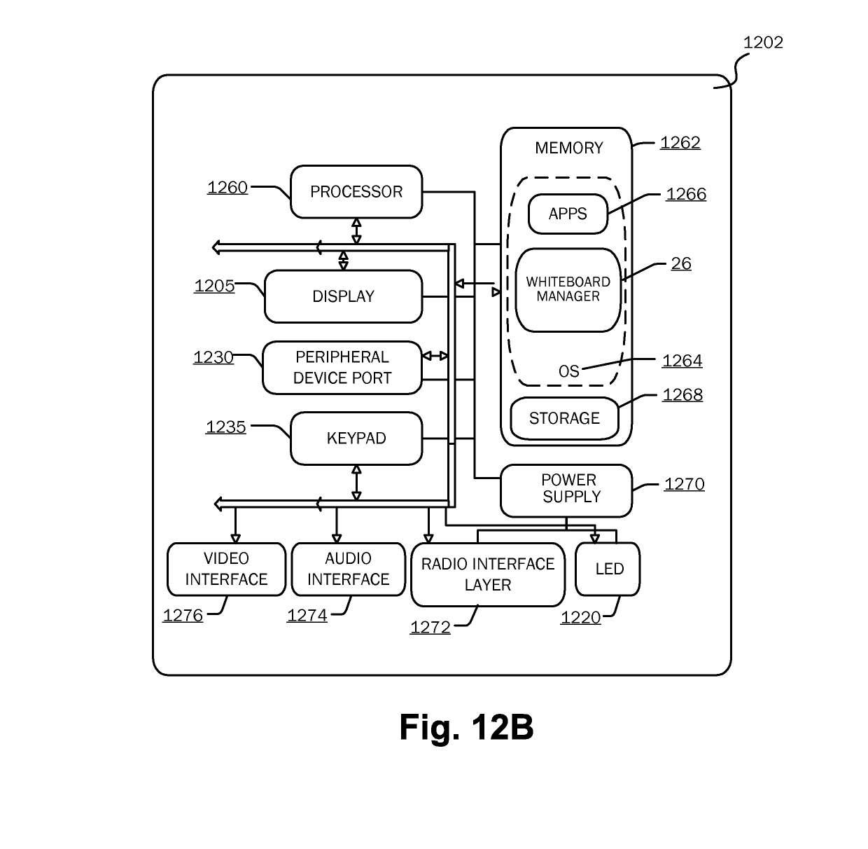

FIGS. 12A and 12B illustrate a mobile computing device 1200, for example, a mobile telephone, a smart phone, a tablet personal computer, a laptop computer, and the like, with which embodiments of the invention may be practiced. With reference to FIG. 12A, one embodiment of a mobile computing device 1200 for implementing the embodiments is illustrated. In a basic configuration, the mobile computing device 1200 is a handheld computer having both input elements and output elements. The mobile computing device 1200 typically includes a display 1205 and one or more input buttons 1210 that allow the user to enter information into the mobile computing device 1200. The display 1205 of the mobile computing device 1200 may also function as an input device (e.g., a touch screen display). If included, an optional side input element 1215 allows further user input. The side input element 1215 may be a rotary switch, a button, or any other type of manual input element. In alternative embodiments, mobile computing device 1200 may incorporate more or less input elements. For example, the display 1205 may not be a touch screen in some embodiments. In yet another alternative embodiment, the mobile computing device 1200 is a portable phone system, such as a cellular phone. The mobile computing device 1200 may also include an optional keypad 1235. Optional keypad 1235 may be a physical keypad or a “soft” keypad generated on the touch screen display. In various embodiments, the output elements include the display 1205 for showing a graphical user interface (GUI), a visual indicator 1220 (e.g., a light emitting diode), and/or an audio transducer 1225 (e.g., a speaker). In some embodiments, the mobile computing device 1200 incorporates a vibration transducer for providing the user with tactile feedback. In yet another embodiment, the mobile computing device 1200 incorporates input and/or output ports, such as an audio input (e.g., a microphone jack), an audio output (e.g., a headphone jack), and a video output (e.g., a HDMI port) for sending signals to or receiving signals from an external device.

FIG. 12B is a block diagram illustrating the architecture of one embodiment of a mobile computing device. That is, the mobile computing device 1200 can incorporate a system (i.e., an architecture) 1202 to implement some embodiments. In one embodiment, the system 1202 is implemented as a “smart phone” capable of running one or more applications (e.g., browser, e-mail, calendaring, contact managers, messaging clients, games, and media clients/players). In some embodiments, the system 1202 is integrated as a computing device, such as an integrated personal digital assistant (PDA) and wireless phone.

One or more application programs 1266 may be loaded into the memory 1262 and run on or in association with the operating system 1264. Examples of the application programs include phone dialer programs, e-mail programs, personal information management (PIM) programs, word processing programs, spreadsheet programs, Internet browser programs, messaging programs, and so forth. The system 1202 also includes a non-volatile storage area 1268 within the memory 1262. The non-volatile storage area 1268 may be used to store persistent information that should not be lost if the system 1202 is powered down. The application programs 1266 may use and store information in the non-volatile storage area 1268, such as e-mail or other messages used by an e-mail application, and the like. A synchronization application (not shown) also resides on the system 1202 and is programmed to interact with a corresponding synchronization application resident on a host computer to keep the information stored in the non-volatile storage area 1268 synchronized with corresponding information stored at the host computer. As should be appreciated, other applications may be loaded into the memory 1262 and run on the mobile computing device 1200, including the whiteboard manager 26 as described herein.

The system 1202 has a power supply 1270, which may be implemented as one or more batteries. The power supply 1270 might further include an external power source, such as an AC adapter or a powered docking cradle that supplements or recharges the batteries.

The system 1202 may also include a radio 1272 that performs the function of transmitting and receiving radio frequency communications. The radio 1272 facilitates wireless connectivity between the system 1202 and the “outside world,” via a communications carrier or service provider. Transmissions to and from the radio 1272 are conducted under control of the operating system 1264. In other words, communications received by the radio 1272 may be disseminated to the application programs 1266 via the operating system 1264, and vice versa.

The visual indicator 1220 may be used to provide visual notifications, and/or an audio interface 1274 may be used for producing audible notifications via the audio transducer 1225. In the illustrated embodiment, the visual indicator 1220 is a light emitting diode (LED) and the audio transducer 1225 is a speaker. These devices may be directly coupled to the power supply 1270 so that when activated, they remain on for a duration dictated by the notification mechanism even though the processor 1260 and other components might shut down for conserving battery power. The LED may be programmed to remain on indefinitely until the user takes action to indicate the powered-on status of the device. The audio interface 1274 is used to provide audible signals to and receive audible signals from the user. For example, in addition to being coupled to the audio transducer 1225, the audio interface 1274 may also be coupled to a microphone to receive audible input, such as to facilitate a telephone conversation. In accordance with embodiments of the present invention, the microphone may also serve as an audio sensor to facilitate control of notifications, as will be described below. The system 1202 may further include a video interface 1276 that enables an operation of an on-board camera to record still images, video stream, and the like.

A mobile computing device 1200 implementing the system 1202 may have additional features or functionality. For example, the mobile computing device 1200 may also include additional data storage devices (removable and/or non-removable) such as, magnetic disks, optical disks, or tape. Such additional storage is illustrated in FIG. 12B by the non-volatile storage area 1268. Mobile computing device 1200 may also include peripheral device port.

Data/information generated or captured by the mobile computing device 1200 and stored via the system 1202 may be stored locally on the mobile computing device 1200, as described above, or the data may be stored on any number of storage media that may be accessed by the device via the radio 1272 or via a wired connection between the mobile computing device 1200 and a separate computing device associated with the mobile computing device 1200, for example, a server computer in a distributed computing network, such as the Internet. As should be appreciated such data/information may be accessed via the mobile computing device 1200 via the radio 1272 or via a distributed computing network. Similarly, such data/information may be readily transferred between computing devices for storage and use according to well-known data/information transfer and storage means, including electronic mail and collaborative data/information sharing systems.

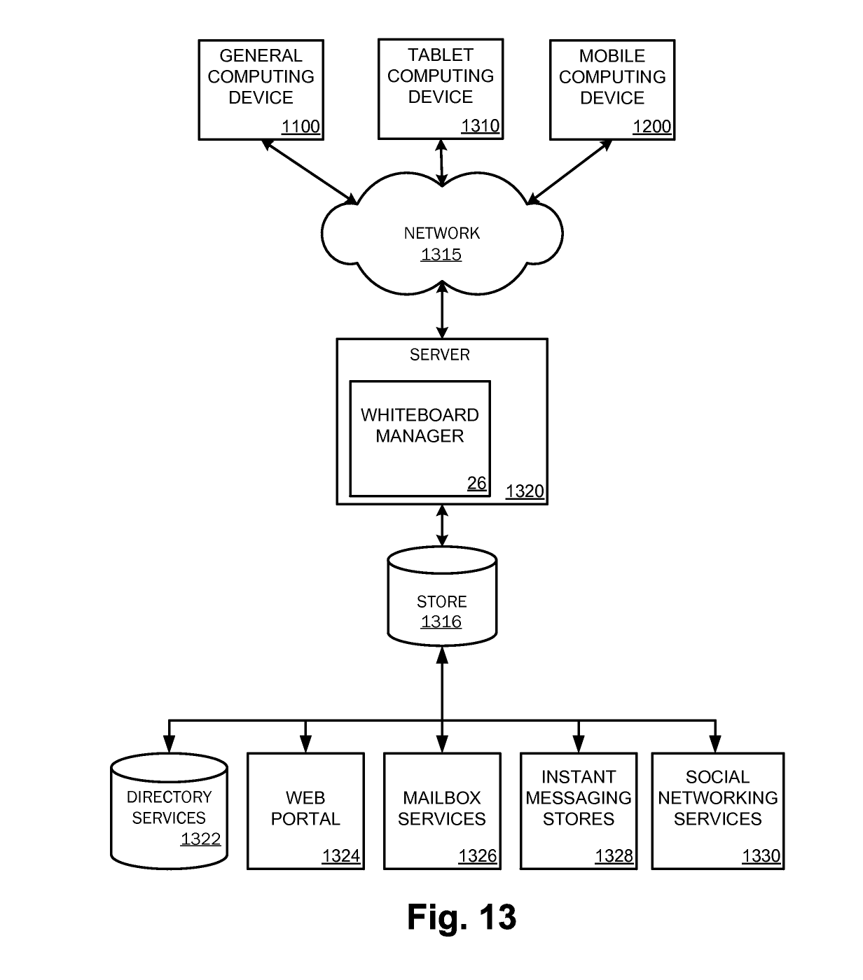

FIG. 13 illustrates an embodiment of an architecture of an exemplary system, as described above. Content developed, interacted with, or edited in association with the whiteboard manager 26 may be stored in different communication channels or other storage types. For example, various documents may be stored using a directory service 1322, a web portal 1324, a mailbox service 1326, an instant messaging store 1328, or a social networking site 1330. The whiteboard manager 26 may use any of these types of systems or the like for enabling data utilization, as described herein. A server 1320 may provide the whiteboard manager 26 to clients. As one example, the server 1320 may be a web server providing the whiteboard manager 26 over the web. The server 1320 may provide the whiteboard manager 26 over the web to clients through a network 1315. By way of example, the client computing device may be implemented as the computing device 1100 and embodied in a personal computer, a tablet computing device 1310 and/or a mobile computing device 1200 (e.g., a smart phone). Any of these embodiments of the client computing device 1100, 1310, 1200 may obtain content from the store 1316.

Embodiments of the present invention, for example, are described above with reference to block diagrams and/or operational illustrations of methods, systems, and computer program products according to embodiments of the invention. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

The description and illustration of one or more embodiments provided in this application are not intended to limit or restrict the scope of the invention as claimed in any way. The embodiments, examples, and details provided in this application are considered sufficient to convey possession and enable others to make and use the best mode of claimed invention. The claimed invention should not be construed as being limited to any embodiment, example, or detail provided in this application. Regardless of whether shown and described in combination or separately, the various features (both structural and methodological) are intended to be selectively included or omitted to produce an embodiment with a particular set of features. Having been provided with the description and illustration of the present application, one skilled in the art may envision variations, modifications, and alternate embodiments falling within the spirit of the broader aspects of the general inventive concept embodied in this application that do not depart from the broader scope of the claimed invention.

What is claimed is:

1. A method for incorporating dynamic content onto a whiteboard, comprising:
displaying a whiteboard that is shareable and is configured to display different types of content;
including dynamic content on the whiteboard;
determining a current mode of the dynamic content from modes comprising: a live mode where the dynamic content is dynamically updated and an annotated mode where the dynamic content is frozen until changed back to the live mode;
receiving an interaction with the whiteboard; and
updating the whiteboard in response to the interaction.

2. The method of claim 1, wherein including the dynamic content on the whiteboard comprises: receiving a selection of a web page including content that dynamically changes to include on the whiteboard; receiving a location on the whiteboard where to place the web page; and receiving interactions with the web page on the whiteboard that changes a display of the web page on the whiteboard.

3. The method of claim 1, further comprising: receiving ink annotations that covers at least a portion of a display of the dynamic content on the whiteboard.

4. The method of claim 1, further comprising: scaling ink annotations that are associated with the associated dynamic content in response to a resize operation.

5. The method of claim 1, wherein including the dynamic content on the whiteboard comprises displaying a shared screen on the whiteboard.

6. The method of claim 1, further comprising: receiving an interaction with the dynamic content that that changes a display of the dynamic content on the whiteboard.

7. The method of claim 1, further comprising: taking a snapshot of the dynamic content on the whiteboard and receiving an indication of where to locate the snapshot on the whiteboard.

8. The method of claim 1, wherein determining the current mode of the dynamic content comprises: receiving a selection to change to current mode to the annotate mode and while in the annotate mode receiving an annotation on the dynamic content.

9. The method of claim 1, further comprising storing the whiteboard at an online service.

10. A computer-readable medium storing computer-executable instructions for incorporating dynamic content onto a whiteboard, comprising:
displaying a whiteboard that is shareable and is configured to display different types of content;
including dynamic content on the whiteboard that is dynamically updated in response to external changes while the dynamic content is set to a live mode;
receiving a request at an online service to set a mode of the dynamic content to: the live mode or an annotated mode where the dynamic content is frozen;
changing the mode in response to the request;
receiving an interaction with the whiteboard; and
updating the whiteboard in response to the interaction.

11. The computer-readable medium of claim 10, wherein including the dynamic content on the whiteboard comprises: receiving a location on the whiteboard where to place a web page; and updating the web page on the whiteboard in response to interactions with the web page on the whiteboard.

12. The computer-readable medium of claim 10, further comprising:
receiving ink annotations that covers at least a portion of a display of the dynamic content.

13. The computer-readable medium of claim 10, further comprising:
scaling ink annotations that are associated with the associated dynamic content in response to a resize operation.

14. The computer-readable medium of claim 10, wherein including the dynamic content on the whiteboard comprises displaying a shared screen on the whiteboard.

15. The computer-readable medium of claim 10, further comprising: receiving an interaction with the dynamic content that that changes a display of the dynamic content on the whiteboard.

16. The computer-readable medium of claim 10, further comprising: taking a snapshot of the dynamic content and locating the snapshot on the whiteboard.

17. The computer-readable medium of claim 10, wherein receiving the request to set the mode of the dynamic content to the live mode or the annotated mode comprises: changing a selection of dynamic content to the annotate mode; and leaving the other dynamic content in a live mode.

18. A system for incorporating dynamic content onto a whiteboard, comprising:
a processor and memory;
an operating environment executing using the processor;
a whiteboard that is sharable between different users; and
a whiteboard manager that is configured to perform actions comprising:
displaying the whiteboard that is configured to display different types of content;
including dynamic content on the whiteboard that is dynamically updated in response to external changes while the dynamic content is set to a live mode;
receiving ink annotations on a display of the dynamic content; and
associating the ink annotations with the dynamic content.

19. The system of claim 18, wherein including the dynamic content on the whiteboard comprises: receiving a selection of a web page including content that dynamically changes; and receiving interactions with the web page on the whiteboard that changes a display of the web page on the whiteboard.

20. The system of claim 18, further comprising: scaling the ink annotations that are associated with the dynamic content in response to a resize operation.
